(19) United States
(12) Patent Application Publication
(10) Pub. No.: US 2026/0061997 A1
(43) Pub. Date: Mar. 5, 2026

(54) OBJECT DETECTION SYSTEM

(71) Applicant: NISSAN NORTH AMERICA, INC., Franklin, TN (US)

(72) Inventor: Luis Lorenzo BILL, Dale City, CA (US)

(21) Appl. No.: 18/819,900

(22) Filed: Aug. 29, 2024

(51) Int. Cl. B60W 30/09; G06V 20/58; H04W 4/46

(52) U.S. Cl. CPC B60W 30/09; G06V 20/58; H04W 4/46; B60W 2756/10

(57) ABSTRACT

A system for detecting an object includes a sensor, an electronic controller, and an indicator. The sensor is configured to detect information relating to a presence of an object. The electronic controller is configured to determine the presence of the object based on a change in the information detected by the sensor. An indicator is configured to indicate detection of the presence of the object.

### BACKGROUND

### Technical Field

The present disclosure generally relates to an object detection system. More specifically, the present disclosure relates to an object detection system for a vehicle that facilitates detecting an occluded object.

### Background Information

Conventional object detection systems use sensors to directly detect and measure a distance to an object in the environment. However, when an intermediate object is positioned between the sensor and an object of interest, the object of interest cannot be directly detected by the sensors of the conventional object detection system. The inability to detect the object of interest poses a possible threat to the person and/or vehicle that cannot detect the occluded, or otherwise blocked, object of interest.

### SUMMARY

Accordingly, a need exists for an improved object detection system that facilitates detecting an occluded, or otherwise not directly detectable, object.

In view of the state of the known technology, one aspect of the present disclosure is to provide a system for detecting an object. The system includes a sensor, an electronic controller, and an indicator. The sensor is configured to detect information relating to a presence of an object. The electronic controller is configured to determine the presence of the object based on a change in the information detected by the sensor. An indicator is configured to indicate detection of the presence of the object.

Another aspect of the present disclosure is to provide a system for detecting an object for an autonomous vehicle. The object detection system includes a sensor, an electronic controller, and a vehicle control system. The sensor is configured to detect information relating to a presence of an object. The electronic controller is configured to determine the presence of the object based on a change in the information detected by the sensor. The object is not directly locatable by the autonomous vehicle. The electronic controller is configured to change a control of the vehicle control system upon detecting the presence of the object.

Also other objects, features, aspects and advantages of the disclosed object detection system will become apparent to those skilled in the art from the following detailed description, which, taken in conjunction with the annexed drawings, discloses exemplary embodiments of the object detection system.

### BRIEF DESCRIPTION OF THE DRAWINGS

Referring now to the attached drawings which form a part of this original disclosure:

FIG. 1 is a schematic diagram illustrating a host vehicle equipped with an object detection system in accordance with an exemplary embodiment;

FIG. 2 is a schematic illustration of a host vehicle including the object detection system of FIG. 1 approaching an intersection;

FIG. 3 is a schematic illustration of a host vehicle including the object detection system of FIG. 1 detecting an occluded remote vehicle;

FIG. 4 is an illustration of an infrastructure indicating an approaching occluded remote vehicle;

FIG. 5 is a schematic illustration of an object detection system of FIG. 1; and

FIG. 6 is a flowchart illustrating detection of an object in accordance with the system of FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

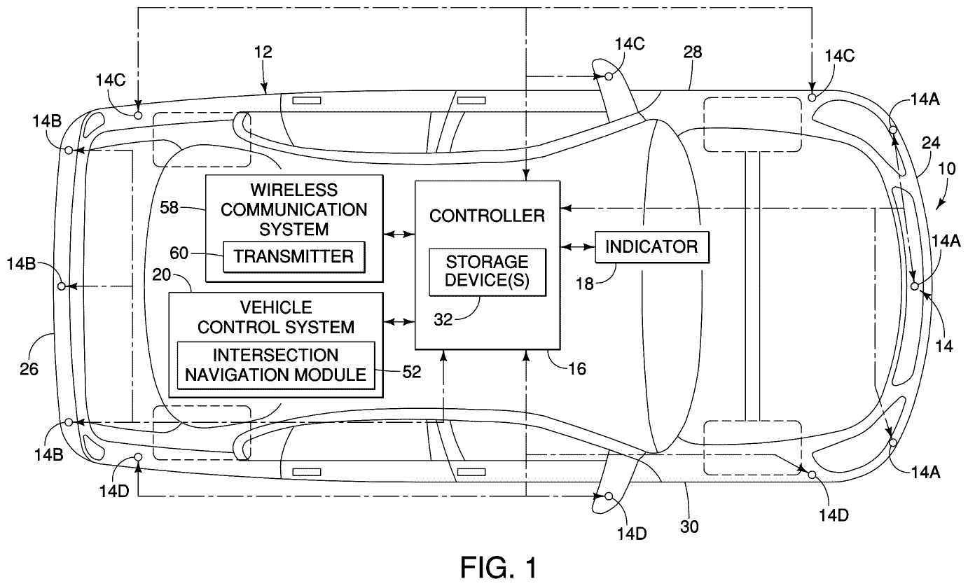

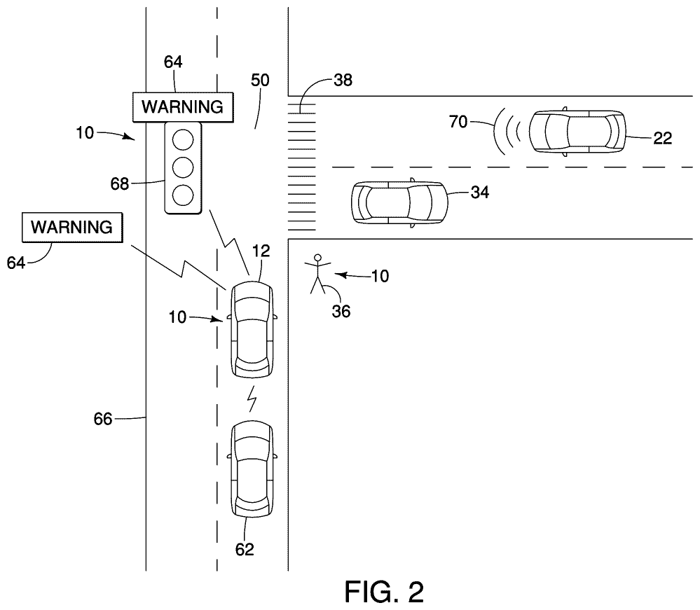

The object detection system 10 for a host vehicle 12 includes a sensor 14, an electronic controller 16, and an indicator 18, as shown in FIG. 1. The object detection system 10 can further include a vehicle control system 20. The object detection system 10 facilitates detecting an object 22, such as an occluded object, as shown in FIG. 2, that is not directly detectable by the host vehicle 12. The object 22 can be an oncoming remote vehicle 22, a bicycle, a pedestrian, or other object moving towards the intersection 50 that poses a possible threat to the host vehicle passing through the intersection 50. Although the object detection system 10 is described with reference to a host vehicle 12, the object detection system can be used in any suitable manner, such as by a pedestrian, a bicycle, or other mobile object. The host vehicle 12 can be an autonomous vehicle.

The host vehicle 12 is equipped with at least one sensor 14 that can generate or capture vehicle environment information, as shown in FIGS. 1 and 2. The sensor 14 is configured to detect information relating to a presence of the object 22. The vehicle 10 is preferably provided with a plurality of sensors 14. Four sensors 14A, 14B, 14C and 14D are provided, although any suitable number of sensors can be used. The plurality of sensors 14 include a front sensor 14A, a rear sensor 14B, a first, or driver's, side sensor 14C and a second, or passenger's, side sensor 14D. The front sensor 14A is preferably centrally located on a front bumper 24 of the vehicle 12. Additional front sensors 14A can be disposed on opposite ends of the front bumper 26. The rear sensor 14B is preferably centrally located on the rear bumper 26. Additional rear sensors 14B can be disposed on opposite ends of the rear bumper 26. The first side sensor 14C and the second side sensor 14D are disposed on the respective sides 28 and 30 of the vehicle 12, such as on an exterior side mirror or proximate a lower surface of the vehicle body structure beneath a door. Additional first and second side sensors 14C and 14D can be spaced along the respective sides 28 and 30 of the vehicle 12. Although the exemplary embodiments of the present invention can be practiced with a single sensor 14, providing a sensor on additional sides of the vehicle 12 allows an object to be detected from any side of the vehicle 12. Additional sensors 14 on each side of the vehicle increase the accuracy and coverage of detecting an object.

The sensor 14 can be any of a plurality of differing types of sensors, often referred to as detection and ranging sensors or devices. The sensor 14 can be, but is not limited to, a depth camera, an ultrasonic sensor, a light detection and ranging (LiDAR) sensor, a camera and/or a microphone.

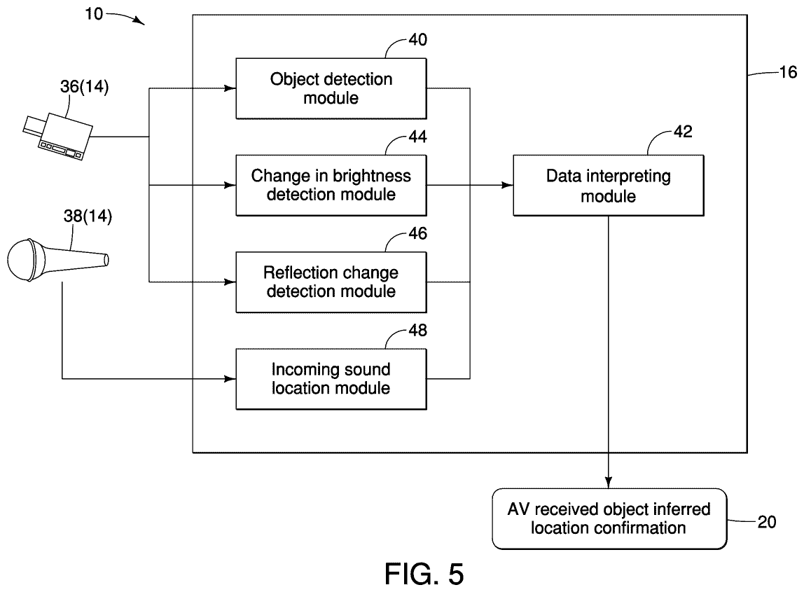

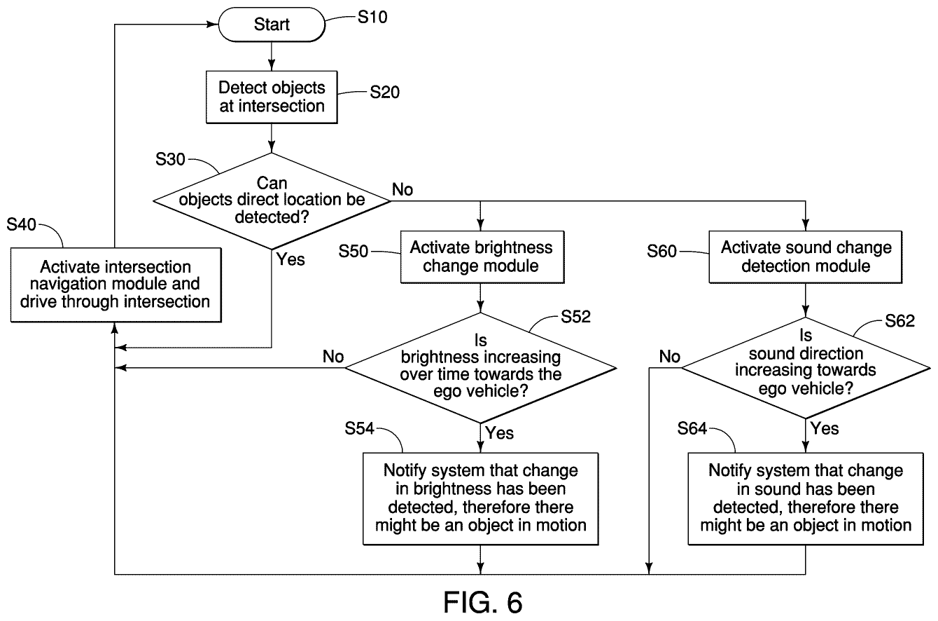

The electronic controller 16 is configured to determine a presence of the object 22 based on a change in the information detected by the sensor 14, as shown in FIGS. 1 and 2. The electronic controller 16 preferably includes a microcomputer with a control program that controls the components of the object detection system 10 as discussed below. The electronic controller 16 includes other conventional components, such as an input interface circuit, an output interface circuit, and storage device(s) 32, such as a ROM (Read Only Memory) device and a RAM (Random Access Memory) device. The microcomputer of the electronic controller 16 is at least programmed to control the object detection system 10 in accordance with the schematic of FIG. 5 and the flowchart of FIG. 6 discussed below. The microcomputer of the electronic controller 16 is programmed to control the sensor 14, the indicator 18, and the vehicle control system 20, and to make determinations or decisions, as discussed herein. The memory circuit stores processing results and control programs, such as ones for the sensor 14, the indicator 18, and the vehicle control system 20. The electronic controller 16 is operatively coupled to the sensor 14, the indicator 18, and the vehicle control system 20 in a conventional manner, as well as other electrical systems in the host vehicle 10, such as the turn signals, windshield wipers, lights and any other suitable systems. Such a connection enables the electronic controller 16 to monitor and control any of these systems as desired. The internal RAM of the electronic controller 16 stores statuses of operational flags and various control data. The internal ROM of the electronic controller 16 stores the information for various operations. The electronic controller 16 is capable of selectively controlling any of the components of the object detection system 10 in accordance with the control program. It will be apparent to those skilled in the art from this disclosure that the precise structure and algorithms for the electronic controller 16 can be any combination of hardware and software that will carry out the functions of the exemplary embodiments of the present invention. Furthermore, the electronic controller 16 can communicate with the other components of the vehicle communication system discussed herein via, for example a controller area network (CAN) bus or in any other suitable manner as understood in the art.

The indicator 18 is configured to indicate the detection of the presence of the object 20, as shown in FIGS. 1 and 2. The indicator 18 can be any suitable device configured to indicate that the presence of the occluded, or otherwise blocked, object 22 has been detected. The indicator 18 can be a display screen or an indicator light configured to visually indicate that the presence of the object 22 has been detected. Alternatively, or in addition to a visual indicator, the indicator 18 can audibly indicate, such as with an alarm or a verbal message, that the presence of the object 22 has been detected.

As shown in FIG. 2, the host vehicle 12 approaching an intersection 50 cannot directly detect the oncoming remote vehicle 22. The first remote vehicle 34 blocks the oncoming remote vehicle 22, such that the sensor 14 (FIG. 1) of the host vehicle 12 cannot directly detect the presence of the oncoming remote vehicle 22. The pedestrian 36 approaching the crosswalk 38 cannot directly detect the oncoming remote vehicle 22 due to the presence of the first remote vehicle 34 blocking directly observing the oncoming remote vehicle 22. The object detection system 10 facilitates detecting the presence of the object 22 when the object cannot be directly detected. The object detection system 10 can be disposed in a mobile device, such as a mobile phone or a mixed reality headset, such that the object detection system 10 can be used by the pedestrian 36, bicycle, or other remote object. The mobile device is configured to be carried or worn by the person using the object detection system.

As shown in FIG. 5, the sensor 14 of the object detection system 10 can be an image sensor 36, such as a camera or a LiDAR, or a sound sensor 38, such as a microphone. The image sensor 36 is configured to directly detect objects, and to also detect changes in brightness and reflections of the objects. The sound sensor 38 is configured to detect sound, sound location, and changes in sound intensity. In other words, the sensor 14 allows the host vehicle 12 to detect and recognize objects, changes in brightness, changes in reflection, changes in sound, and changes in sound direction. The object detection system 10 facilitates directly detecting the object 22 and indirectly detecting the object 22 when the object cannot be directly detected. The sensor 14 can include at least one image sensor 36 and/or at least one sound sensor 38.

When the object 22 can be directly detected by the image sensor 36 of the host vehicle 12, a conventional object detection module 40 of the object detection system 10 transmits the information to a data interpreting module 42 of the object detection system 10, as shown in FIG. 5. The data interpreting module 42 transmits information regarding the directly detected object to the vehicle control system 20.

When the object 22 cannot be directly detected by the image sensor 36, as shown in FIG. 2-4, a change in brightness detection module 44 or a reflection change detection module 46 of the object detection system 10 transmits information relating to the presence of the object 22 to the data interpreting module 42, as shown in FIG. 5. The data interpreting module 42 transmits information regarding the indirectly detected object 22 to the vehicle control system 20.

When the object 22 cannot be directly detected by the image sensor 36, as shown in FIG. 2-4, an incoming sound location module 48 of the object detection system 10 transmits information relating to the presence of the object 22 to the data interpreting module 42, as shown in FIG. 5. The data interpreting module 42 transmits information regarding the indirectly detected object 22 to the vehicle control system 20. The incoming sound module 48 can be used simultaneously with, before, or after use of the change in brightness detection module 44 and the reflection change detection module 46.

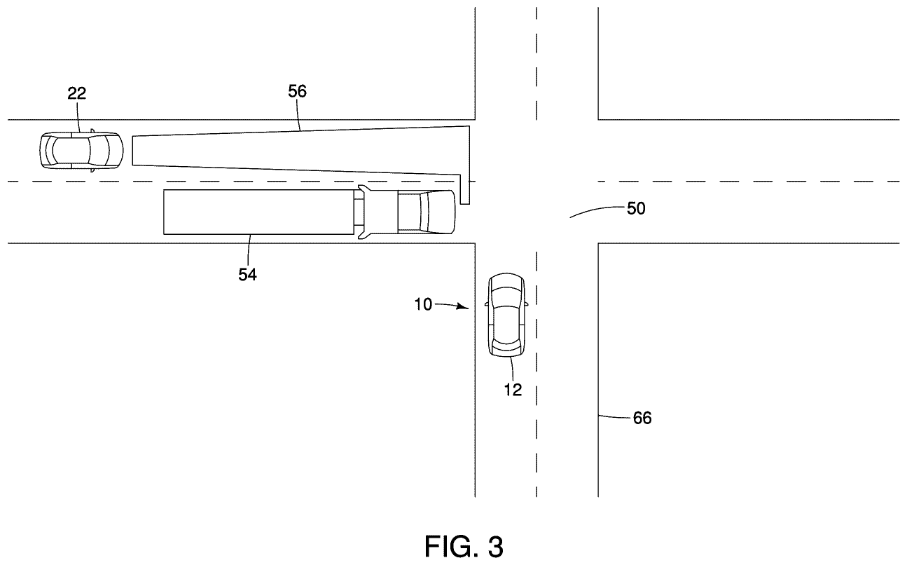

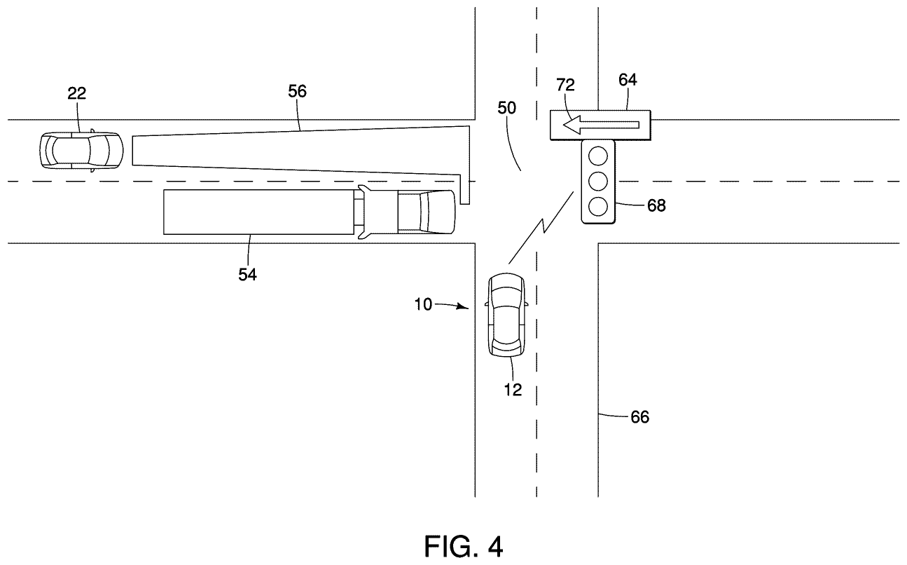

A flowchart of the operation of the object detection system 10 disposed in an autonomous vehicle is illustrated in FIG. 6. The object detection system 10 is initiated at step S10 when the host vehicle 12 is approaching an intersection 50, as shown in FIG. 2-4. The object detection system 10 detects objects at the intersection 50 in step S20. In step S30, a determination is made whether the object can be directly detected. When the object can be directly detected, such as the remote vehicle 34 in FIG. 2 or the remote vehicle 54 in FIGS. 3 and 4, the process moves to step S40. When the object cannot be directly detected, the process moves to steps S50 and S60. Although steps S50 and S60 are shown occurring substantially simultaneously, steps S50 and S60 can be performed in series, with either step S50 or S60 being performed first.

In step S40, when the object can be directly detected, the electronic controller 16 causes the vehicle control system 20 to activate an intersection navigation module 52 of the vehicle control system 20. The intersection navigation module 52 is a conventional control system that controls the autonomous vehicle 12 through the intersection 50 based on the direct detection of the object. The host vehicle 12 proceeds through the intersection with the intersection navigation module 52 activated. The intersection navigation module is deactivated a predetermined amount of time after the host vehicle 12 passes through the intersection 50.

As shown in FIG. 2, the remote vehicle 34 prevents the host vehicle 12 from directly detecting the oncoming remote vehicle 22 as the host vehicle 12 approaches the intersection 50. As shown in FIGS. 3 and 4, the remote vehicle 54, such as a parked delivery truck, prevents the host vehicle 12 from directly detecting the oncoming remote vehicle 22 as the host vehicle 12 approaches the intersection 50. The process moves to steps S50 and S60 to determine whether an oncoming vehicle 22 can be indirectly detected. The steps S50 and S60 can be performed substantially simultaneously, or steps S50 and S60 can be performed in series such that one of steps S50 and S60 is performed before the other of steps S50 and S60.

In step S50, the change in brightness detection module 44 (FIG. 5) is activated. The process moves to step S52 in which a determination is made whether the brightness is increasing over time towards the host vehicle 12. The change in brightness can be detected in any suitable manner, such as template matching to analyze pixel changes. When increasing brightness towards the host vehicle 12 is detected, such as the light 56 emitted by the oncoming vehicle 22 in FIG. 3, the process moves to step S54. When increasing brightness towards the host vehicle 12 is not detected, the process moves to step S40 and the intersection navigation module 52 of the vehicle control system 20 is activated. The host vehicle 12 then proceeds through the intersection 50.

In step S54, the electronic controller 16 notifies the vehicle control system 20 that a change in brightness has been detected. This notification alerts the vehicle control system 20 that an object, such as the oncoming remote vehicle 22, might be in motion towards the host vehicle 12. The process moves to step S40 and the intersection navigation module 52 of the vehicle control system 20 is activated. The intersection navigation module 52 controls the host vehicle 12 through the intersection based on the detection of a possible oncoming remote vehicle 22. The intersection navigation module 52 controls the host vehicle 12 to proceed cautiously through the intersection 50, such as by causing the host vehicle 12 to yield, slow or stop. In other words, the electronic controller 16 is configured to change a control of the vehicle control system 20 upon detecting the presence of the object 22.

In step S60, the sound change detection module 48 (FIG. 5) is activated. The process moves to step S62 in which a determination is made whether the sound direction is increasing over time towards the host vehicle 12. The change in sound direction can be detected in any suitable manner. When increasing sound direction towards the host vehicle 12 is detected, the process moves to step S64. When increasing sound direction towards the host vehicle 12 is not detected, the process moves to step S40 and the intersection navigation module 52 of the vehicle control system 20 is activated. The host vehicle 12 then proceeds through the intersection 50.

In step S64, the electronic controller 16 notifies the vehicle control system 20 that a change in sound direction has been detected. This notification alerts the vehicle control system 20 that an object, such as the oncoming vehicle 22, might be in motion towards the host vehicle 12. The process moves to step S40 and the intersection navigation module 52 of the vehicle control system 20 is activated. The intersection navigation module 52 controls the host vehicle 12 through the intersection based on the detection of a possible oncoming vehicle 22. The intersection navigation module 52 controls the host vehicle to proceed cautiously through the intersection 50, such as by causing the host vehicle 12 to yield, slow or stop. In other words, the electronic controller 16 is configured to change a control of the vehicle control system 20 upon detecting the presence of the object 22.

Although not shown in FIG. 6, the process can include steps similar to steps S50 through S54 in which the reflection change detection module 46 (FIG. 5) of the electronic controller 16 detects a change in a reflection on another surface. The reflection can be a light reflection, such as headlights reflecting on another vehicle, a reflection of the object itself reflecting on other vehicles or surfaces, or a shadow of the object on a surface of the road. In other words, the reflection is a representation of the object on another surface. When a change in the reflection is detected, which is detected in a conventional manner, the intersection navigation module 52 controls the host vehicle to proceed cautiously through the intersection 50. When a change in the reflection is not detected, the intersection navigation module 52 controls the host vehicle 12 through the intersection 50 based on an object not being directly or indirectly detected. For example, a shadow of an occluded vehicle 22 in FIG. 3 approaching the intersection 50 can be detected before the occluded vehicle 22 is directly detectable. A reflection of the occluded vehicle 22 in FIG. 3 approaching the intersection 50 can be detected on another surface before the occluded vehicle 22 is directly detectable.

The flowchart of FIG. 6 uses information relating to a presence of an object 22 detected by the sensor 14 (FIG. 1) to determine the presence of the object 22 based on a change in the information detected by the sensor 14. The information can be light 56 emitted by the object 22, as shown in FIG. 3. The presence of the object 22 can be determined based on detecting a change in a luminance of the light 56 emitted by the object 22. The information can be sound emitted by the object 22. The presence of the object 22 can be determined based on detecting a change in the sound emitted by the object 22. The information can be a reflection, such as reflection of light 56 emitted by the object 22 or reflection of the object 22 itself. The presence of the object 22 is determined based on detecting a change in the reflection of the object 22. As shown in FIG. 3, the object 22 can be a remote vehicle.

The flowchart of FIG. 6 is applicable to the object detection system 10 being used by a pedestrian, a bicycle, or other mobile object externally of a vehicle. The flowchart is substantially similar except that the intersection navigation module 52 is not activated.

As shown in FIG. 3, as the host vehicle 12 approaches the intersection 50, the parked truck 54 blocks, or occludes, the oncoming remote vehicle 22 from being directly detected by the host vehicle 12. As the oncoming remote vehicle 22 approaches the intersection 50, there is a variation, or change, in, but not limited to, light conditions due to the increased luminance of the light 56 emitted by the oncoming remote vehicle 22. As the oncoming remote vehicle 22 nears the intersection 50, the environment around the intersection becomes brighter. The object detection system 10 of the host vehicle 12 detects the change and increase in the brightness of the emitted light 56 to determine that another vehicle, or object, is approaching the intersection 50. The host vehicle 12 can also detect a change in a reflection of the object 22 approaching the intersection 50, or a change in the sound emitted by the object 22 approaching the intersection 50. The change in emitted light, the reflection, or the emitted sound by the object 22 is detected in a conventional manner. Alternatively, the host vehicle 12 can include an inertial measurement unit (IMU) configured to detect vibrations, and a change in the vibrations as the object 22 approaches the intersection 50. The detection of an occluded oncoming vehicle 22 can be based on detecting an increase in vibrations as the oncoming vehicle 22 approaches the intersection 50.

As shown in FIGS. 1 and 2, the host vehicle 12 can be an autonomous vehicle including the sensor 14, the electronic controller 16, and the indicator 18. The autonomous vehicle 12 further includes the vehicle control system 20. The vehicle control system 20 is activated to change a control of the autonomous vehicle upon detecting the presence of the object 22, such as causing the autonomous vehicle to yield or slow down through the intersection 50 or to stop before entering the intersection 50.

As shown in FIG. 1, the host vehicle 12 includes a wireless communication system 58 that includes a transmitter 60. As shown in FIG. 2, the transmitter 60 of the host vehicle 12 is configured to transmit the detection of the object 22 to another remote vehicle 62 through vehicle to vehicle (V2V) communication. When the object detection system 10 of the host vehicle 12 indirectly detects the oncoming vehicle 22 occluded by the remote vehicle 34, the transmitter 60 of the host vehicle 12 transmits a communication to another remote vehicle 62 that an occluded object 22 is approaching the intersection 50. The transmitter 60 of the host vehicle 12 can be configured to transmit the detection of the object 22 to a display 64 mounted adjacent a road 66 on which the host vehicle 12 is traveling through vehicle to infrastructure (V2I) communication. Alternatively, the display 64 can be mounted on a traffic light 68, or other sign, mounted adjacent the road 66, as shown in FIGS. 2 and 4. The display 64 displays text or an illustration alerting other vehicles, pedestrians and cyclists regarding an approaching occluded object 22. The display can include an arrow 72 indicating a direction from which the detected occluded object 22 is approaching the intersection 50. The display 64 is configured to be detected by an autonomous vehicle or can transmit a message to an autonomous vehicle. Alternatively, the host vehicle 12 can have a display mounted externally of the host vehicle 12, such as on the roof of the host vehicle 12, that displays text or an illustration indicating that the host vehicle 12 is proceeding cautiously through the intersection 50 based on the detection of an occluded oncoming vehicle 22.

As shown in FIG. 2, an infrastructure, such as a traffic light 68, includes the object detection system 10. In other words, the infrastructure includes the sensor 14, the electronic controller 16, and the indicator 18. The infrastructure 68 is mounted adjacent the road 66. The infrastructure 68 is configured to be visible from the road 66. The object detection system 10 of the infrastructure displays text or an illustration on the indicator 18, which can be a display 64 mounted on the infrastructure 68, that an occluded vehicle 22 is approaching the intersection 50.

As shown in FIG. 2, the sensor 14 of the object detection system 10 can detect radio waves 70 emitted by a remote vehicle 22. In other words, radio waves emitted by the remote vehicle 22 is the information relating to a presence of the remote vehicle 22 that is detected by the sensor 14 and used to determine that an occluded oncoming remote vehicle 22 is approaching the intersection 50.

The object detection system 10 facilitates detecting occluded objects, such as vehicles, bicycles, pedestrians and other mobile objects, that are approaching the intersection 50. The object detection system 10 can be used in any environment in which the detection of the occluded object facilitates safe traveling by the object employing the object detection system 10, such as a vehicle, bicycle, pedestrian or other mobile object.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle, or other mobile object, equipped with the object detection system. Accordingly, these terms, as utilized to describe the present invention should be interpreted relative to a vehicle, or other mobile object, equipped with the vehicle detection system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A system for detecting an object, the system comprising:
a sensor configured to detect information relating to a presence of an object;
an electronic controller configured to determine the presence of the object based on a change in the information detected by the sensor; and
an indicator configured to indicate detection of the presence of the object.

2. The system according to claim 1, wherein
the information is light emitted by the object.

3. The system according to claim 2, wherein
the presence of the object is determined based on detecting a change in a luminance of the light emitted by the object.

4. The system according to claim 3, wherein
the object is a remote vehicle.

5. The system according to claim 2, wherein
the information is sound emitted by the object.

6. The system according to claim 5, wherein
the presence of the object is determined based on detecting a change in the sound emitted by the object.

7. The system according to claim 6, wherein
the object is a remote vehicle.

8. The system according to claim 2, wherein
the information is a reflection of the object.

9. The system according to claim 8, wherein
the presence of the object is determined based on detecting a change in the reflection of the object.

10. The system according to claim 9, wherein
the object is a remote vehicle.

11. The system according to claim 1, wherein
an autonomous vehicle includes the sensor, the electronic controller, and the indicator.

12. The system according to claim 11, wherein
the autonomous vehicle includes a vehicle control system.

13. The system according to claim 12, wherein
the vehicle control system is activated to change a control of the autonomous vehicle upon detecting the presence of the object.

14. The system according to claim 11, wherein
the autonomous vehicle includes a transmitter configured to transmit the detection of the object to another remote vehicle.

15. The system according to claim 11, wherein
the autonomous vehicle includes a transmitter configured to transmit the detection of the object to a display mounted adjacent a road.

16. The system according to claim 1, wherein
a mobile device includes the sensor, the electronic controller, and the indicator, the mobile device being configured to be worn or carried by a person.

17. A system for detecting an object for an autonomous vehicle, the system comprising:
a sensor configured to detect information relating to a presence of an object;
an electronic controller configured to determine the presence of the object based on a change in the information detected by the sensor, the object not being directly locatable by the autonomous vehicle; and
a vehicle control system,
the controller being configured to change a control of the vehicle control system upon detecting the presence of the object.

18. The system according to claim 17, wherein
the information is light emitted by the object.

19. The system according to claim 17, wherein
the information is sound emitted by the object.

20. The system according to claim 17, wherein
the information is a reflection of the object.
